(19) United States
(12) Patent Application Publication
(10) Pub. No.: US 2022/0187792 A1
(43) Pub. Date: Jun. 16, 2022

(54) Method for Operating a Machine Tool and a Machine Tool

(71) Applicant: Siemens Aktiengesellschaft, München (DE)

(72) Inventor: Daniel Regulin, München (DE)

(73) Assignee: Siemens Aktiengesellschaft, München (DE)

(21) Appl. No.: 17/442,718

(22) PCT Filed: Mar. 19, 2020
(86) PCT No.: PCT/EP2020/057590

§ 371 Date: Sep. 24, 2021

(30) Foreign Application Priority Data
Mar. 26, 2019 (EP) 19165248.6

(51) Int. Cl. G05B 19/4093; G05B 19/404; G05B 13/04

(52) U.S. Cl. CPC G05B 19/40938; G05B 19/404; G05B 2219/37355; G05B 2219/37576; G05B 13/042

(57) ABSTRACT

Various embodiments of the teachings herein include a method for operating a machine tool comprising: during a machining process in which a first workpiece of a first batch is machined using the machine tool, detecting a measured variable using a detection device of the machine tool; determining a measured value characterizing the machining process as a function of the measured variable using an electronic computing device; and comparing the determined measured value with a reference function determined before the machining process using a reference machining process carried out before the machining process using the machine tool and/or by a further machine tool and stored in an electronic memory device, the reference function characterizing the reference machining process to machine a second workpiece of a second batch.

### CROSS-REFERENCE TO RELATED APPLICATIONS

This application is a U.S. National Stage Application of International Application No. PCT/EP2020/057590 filed Mar. 19, 2020, which designates the United States of America, and claims priority to EP Application No. 19165248.6 filed Mar. 26, 2019, the contents of which are hereby incorporated by reference in their entirety.

### TECHNICAL FIELD

The present disclosure relates to machine tools. Various embodiments of the teachings herein include methods for operating a machine tool and/or machine tools.

### BACKGROUND

WO 2012/153157 A2 describes a method for optimizing cutting forces in a milling process for machining a workpiece by means of a milling tool. An example numerical control system is described in DE 10 2017 000 471 A1. In addition, a system for determining the wear state of a machine tool is described in DE 10 2006 006 273 A1.

### SUMMARY

The teachings of the present disclosure provide methods and machine tools allowing workpieces of different batches to be machined in a particularly process-reliable manner by means of the machine tool. For example, some embodiments of the teachings herein include a method for operating a machine tool (12), with the steps: during a machining process in which at least (12) one first workpiece of a first batch is machined by means of the machine tool: detecting at least one measured variable by means of a detection device (16) of the machine tool (12; step S1); determining at least one measured value (32) which characterizes the machining process as a function of the measured variable detected during the machining process by means of an electronic computing device (12; step S2); and comparing the determined measured value with at least one reference function which is determined before the machining process using at least one reference machining process that is carried out before the machining process by means of the machine tool (10) and/or by means of a further machine tool and which is stored in an electronic memory device (18) and characterizes the reference machining process carried out in order to machine at least one second workpiece of a second batch (step S3).

In some embodiments, at least one parameter, which influences machining processes to be carried out by means of the machine tool (12), is set as a function of the comparison.

In some embodiments, the determined measured value is compared with at least one second reference function which is determined before the machining process on the basis of at least one second reference machining process carried out by means of the machine tool and/or by means of a further machine tool before the machining process and which is stored in the electronic memory device (18) and characterizes the second reference machining process carried out in order to machine at least one third workpiece of a third batch.

In some embodiments, the comparison comprises that a combination, in particular a linear combination and preferably a convex combination, of the reference functions is carried out by means of the electronic computing device (12), as a result of which an actual function comprising the measured value (32) and characterizing the machining process is determined.

In some embodiments, at least part of the actual function is visualized by at least one function graph (20, 20′, 20″) by displaying the function graph (20, 20′, 20″ on an electronic display (22).

In some embodiments, at least one first value of at least one first parameter, which influences machining processes to be carried out by means of the machine tool (12), is calculated by means of the electronic computing device (12) in such a way that at least one second value of at least one second parameter, the dependence of which on the first parameter is described by the actual function, fulfils at least one predefinable or predefined criterion.

In some embodiments, the at least one first value of the at least one first parameter is automatically set by means of the electronic computing device (12).

In some embodiments, the at least one first value of the at least one first parameter is set as a function of at least one detected input brought about by a person.

In some embodiments, the at least one criterion is set as a function of at least one detected input brought about by a person and is thereby predefined.

In some embodiments, before the machining process, the reference machining process is carried out, in which process the second workpiece is machined by means of the machine tool (12), wherein during the reference machining process the at least one measured variable is detected by means of the detection device (16) of the machine tool (12), wherein at least one reference measured value characterizing the reference machining process is determined by means of the electronic computing device (12) as a function of the measured variable detected during the reference machining process, and wherein the reference function is determined as a function of the reference measured value.

In some embodiments, the reference function and/or the actual function and/or the measured value (32) and/or the reference measured value and/or the at least one first value of the at least one first parameter is provided and is loaded into a data cloud (66) external with respect to the machine tool (12).

As another example, some embodiments include a machine tool (12) for machining workpieces, wherein the machine tool (12) is designed to carry out a method as described herein.

### BRIEF DESCRIPTION OF THE DRAWINGS

Further advantages, features, and details of the teachings herein are given in the following description of an exemplary embodiment and with reference to the drawings. The features and feature combinations mentioned above in the description and the features and feature combinations mentioned below in the description of the figures and/or shown solely in the figures can be used not only in the combinations disclosed in each case but can also be used in other combinations or alone without departing from the scope of the disclosure. In the drawings:

FIG. 1 shows a diagram illustrating a method and a machine tool incorporating teachings of the present disclosure;

FIG. 2 shows a flowchart illustrating a method incorporating teachings of the present disclosure;

FIG. 3 shows a graph illustrating multi-dimensional functions;

FIG. 4 shows a further graph illustrating multi-dimensional functions;

FIG. 5 shows a further graph illustrating multi-dimensional functions; and

FIG. 6 shows block diagrams illustrating an example method incorporating teachings of the present disclosure.

### DETAILED DESCRIPTION

Some embodiments of the teachings herein include a method for operating a machine tool. The machine tool is designed for machining, in particular for the mechanical machining, of workpieces. For this purpose, the machine tool comprises, for example, at least one tool and at least one drive, by means of which, in order to machine the respective workpiece, at least one relative movement that occurs along at least one axis and/or about at least one axis can be brought about between the workpiece and the tool, in particular while the tool at least temporarily touches the workpiece.

As a result, the respective workpiece can be machined by means of the tool and thus by means of the machine tool, in particular mechanically. The machining which can be effected by means of the machine tool is, for example, cutting machining, in particular by turning or milling. In a first step of the method, at least one measured variable is detected by means of a detection direction of the machine tool during a machining process, in or during which at least one first workpiece of a first batch is machined by means of the machine tool. If, for example, during the cutting machining process, the first workpiece is machined by means of the machine tool and cut, therefore, the machining process is, for example, what is known as a cutting process.

An internal detection device of the machine tool, in other words a detection device which is arranged inside the machine tool and is in any case part of the machine tool, may be used as the detection device, the measurement signal or measurement signals of which is/are used, for example, to operate, in particular to control or regulate, the machine tool during the machining process. In this case, for example, the measured variable is characterized by the measurement signal or by the measurement signals. The respective measurement signal is, for example, an electrical signal. Thus, the measured variable may not be detected or measured, for instance, by additional external sensors, but rather the measured variable by means of the internal detection device, provided in any case and also referred to as a measuring device, of the machine tool and is thus measured.

In a second step of the method, at least one measured value characterizing the machining process is determined by means of an electronic computing device, in particular of the machine tool, as a function of the measured variable detected during the machining process. The machining process, during which the measured variable is detected, is also referred to as the current machining process since during the current machining process at least part of the method is carried out and the measured variable is detected by means of the detection device in the process. In some embodiments, the at least one measured value is determined, e.g. calculated, by the electronic computing device during the machining process, in other words during the current machining process.

In a third step of the method, the determined measured value, in particular by means of the electronic computing device and/or during the machining processor or during the current machining process, is compared with at least one, e.g. multi-dimensional, reference function, determined before the machining process on the basis of at least one reference machining process carried out before the machining process by means of the machine tool and/or by means of a further machine tool, and which is stored in an electronic memory device, in particular the machine tool or the electronic computing device, and characterizes the reference machining process carried out in order to machine at least one second workpiece of a second batch. For this purpose, for example the reference function is retrieved from the memory device. The memory device can be a component of the machine tool and/or components of a controller for operating, in particular controlling or regulating the machine tool, or the memory device is a memory device external in respect of the machine tool and/or the controller, such as a data cloud, also referred to as a cloud. In other words, the reference function can be stored locally on or in the controller, also referred to as a machine controller, or on or in one or more peripheral device(s) of the machine controller and/or, in particular centrally, in a data cloud.

In some embodiments, the reference function is a multi-dimensional function, in other words a multi-dimensional reference function. Furthermore, it is conceivable that the reference function is a one-dimensional function, in other words a one-dimensional reference function. In other words, the reference function characterizes or describes the reference machining process, which was or is carried out before the current machining process by means of the machine tool and/or by means of a further machine tool provided in addition to the machine tool, wherein the second workpiece was or is machined by means of the machine tool or by means of the further machine tool, in particular mechanically and preferably by cutting, in the reference machining process or during the reference machining process. In some embodiments, the second workpiece belonging to the second batch was or is machined during the reference machining process by means of the same machine tool by means of which the first workpiece belonging to the first batch is also machined during the current machining process.

For example, reference values can be obtained or determined on the basis of the reference machining process, which, as a result of the fact that the reference machining process was carried out by means of the machine tool and/or by means of the further machine tool, the reference values can be determined by means of the machine tool and/or by means of the further machine tool. In some embodiments, only an influence of machine-specific factors is compensated in the process, for example by a machine model and/or by a measurement of the specific factors. An example of this is the electric current or a torque of an axis, which is also simply referred to as moment, and which has to be applied without intervention of the tool, for example due to friction.

Comparing the measured value with the reference function can, in particular, be taken to mean that the measured value is set in relation to the reference function and/or is linked to the reference function and/or related to the reference function. In some embodiments, comparing the measured value with the reference function can be taken to mean that that any distinction or possible difference between the measured value and the reference function, in particular between the measured value and at least one function value of the reference function, is visualized and, for example, displayed on an electronic display and/or is determined or calculated, in particular by means of the electronic computing device.

In some embodiments, comparing the measured value with the reference function can be taken to mean that both the reference function and the measured value are used in order to carry out at least one calculation or determination process as a function of the measured value and the reference function in order to thereby determine, in particular calculate, for example, at least one calculation value and/or at least one calculation function. The reference machining process is a machining process carried out by means of the machine tool or by means of the further machine tool, which machining process is or was carried out before the current machining process and is referred to as a reference machining process, in particular for the conceptual differentiation from the current machining process. In order to be able to conceptually differentiate the machining process, during which the measured variable is detected in the first step, from the reference machining process, the machining process, during which the measured variable is detected, is also referred to as a current machining process or a first machining process.

The methods described herein make it possible to adapt the machine tool, in particular the operation thereof, particularly early to the first workpiece or to the first batch and, more precisely, on the basis of findings which have been obtained on the basis of the reference machining process and thus on the basis of a machining of the second workpiece or of the second batch carried out by means of one of the machine tools or by means of the further machine tool. In this case, said findings are reflected, depicted or described by the aforementioned reference function.

In other words, the methods make it possible to adapt the machine tool, in particular the operation thereof, particularly early to the first workpiece or to the first batch, and, more precisely, on the basis of the reference machining process characterized by the reference function and thus on the basis of the second batch which was or is machined at least partially before carrying out the current machining process by means of the machine tool or by means of the further machine tool. The feature that the second batch is or was at least partially processed at least partially processed by means of the machine tool or by means of the further machine tool in the context of the referencing machining process should be taken to mean, in particular, that at least the second workpiece of the second batch is or was machined by means of the machine tool or by means of the further machine tool before carrying out the current machining process.

In particular, by comparing the measured value with the reference function, it is possible to identify any differences between the current machining process and the reference machining process and thus any differences between the workpieces or between the batches particularly early, so then to adapt the machine tool, in particular process parameters for operating, in particular for controlling or regulating, the machine tool, particularly early to these possible differences.

Programs, in particular control or regulating programs, of machine tools or for operating, in particular for controlling or regulating, machine tools are conventionally optimized in terms of tool service life, machining duration and component quality in modern production. However, machinability, in particular cutting machinability, of predefined materials is sometimes subject to considerable fluctuations, which can provide for different tool service lives as a function of respective batches. Without prior analysis of materials, these fluctuations, which are also referred to as variations, cannot currently be taken into account or lead to a defect or damage to the machine tool and to the workpiece to be machined.

The teachings herein accordingly make it possible to analyze a batch, such as the first batch and the second batch, in particular in terms of their characteristics, in particular automatically, so, as a result, particularly advantageous and optimized processing of workpieces and a minimization of disturbances can be achieved. The respective batch is also referred to as a material batch.

In some examples, batches and thus respective workpieces of the batches can differ significantly from one another with regard to their machinability, although the same composition, in particular material composition, of the workpieces of the batches is nominally present. For example, the machinability, in particular the cutting machinability, of the first workpiece can differ from the machinability, in particular cutting machinability, of the second workpiece in that the workpieces, although they are formed from the same material and thus have the same material composition, have been heat-treated in different ways. While the batches can differ from one another, in particular with regard to their machinability, the respective workpieces of the respective batch are very similar or identical to one another, in particular with regard to their machinability. Furthermore, it is conceivable that the workpieces of the same batch can differ from one another, in particular with regard to the shape. Only the method of machining should not significantly differ with regard to the reference function. This deviation of the process is only possible after a plurality of reference functions have been recorded in different operating points, it being possible for a new reference function to be produced by each machining of a component or of a workpiece.

In some embodiments, it is possible to identify, in particular automatically, such possible differences between the workpieces and thus between the batches on the basis of the measured value and on the basis of the reference function particularly early. As a result, for example, the process parameters influencing the operation and thus the machining process or machining processes to be carried out by means of the machine tool can be set as a function of the comparison and in particular be adjusted to the possible differences between the batches, so, in particular, the workpieces of the first batch can be machined, in particular cut, in a process-reliable and therefore time- and cost-effective and/or particularly gentle manner for the machine tool.

Conventionally, any differences between two batches are consequently taken into account or undesired effects, which can result from any differences between two batches, are avoided in that, for example, after machining of a batch, careful entry of a further, new or other batch is carried out within the framework of a production process. In this case, a person operating the machine tool influences the process parameters manually on the basis of process observation and their experience. Furthermore, it is fundamentally conceivable to carry out process monitoring during machining of the new batch by means of a sensor system that is provided in addition to the machine tool and is external in respect of the machine tool, and to output a warning or to stop the process, for example in the event of a defined threshold value being exceeded or fallen below. As a rule, a complete pre-examination of the respective batch with regard to its machinability, in particular cutting machinability, does not take place due to the high outlay.

The methods described herein make it possible to identify and take into account any differences between the batches, in particular automatically, in particular using the internal detection device of the machine tool. Due to the fact that the measured value is detected by means of the detection device and compared with the reference function, a manual adaptation of the process parameters to any batch differences can be avoided or be effectively and efficiently supported, so, for example, the machine tool can be adapted to any differences between the batches in a time- and cost-effective manner, in other words quickly.

Detecting the measured variable is an analysis of the current machining process, which is formed, for example, as a cutting process, wherein, by means of this analysis of the current machining process, any material batch-specific divergences, in other words any difference between the batches, can be compensated, in particular as a result of the fact that the process parameters or at least one parameter influencing machining processes to be carried out by means of the machine tool, which is simply also referred to as a parameter, is set, in particular as a function of the comparison, in other words varies or is varied. For this purpose, for example, measurement data is recorded on the machine tool, in particular by means of software. This measurement data is machine-internal data, which is provided, for example, by the, in particular internal, detection device and characterizes the detected measured variable. For example, the data is characterized or incorporated by the above-mentioned measurement signal. External sensors are thus not necessary and are not provided in order to detect the measured variable.

The measured variable is, for example, a torque, also referred to as simply moment or axis torque, which acts around an axis of the machine tool. In other words, the measured variable can include the aforementioned torque. In some embodiments, the measured variable can be or comprise an electric current, with the electric current flowing, for example, through an electrical or electronic component of the machine tool. In particular, the electric current can be an electric motor current flowing through an electric motor of the machine tool.

In other words, the electric motor is supplied with the motor current to thereby operate the electric motor. The electric motor is, for example, a component of the above-mentioned drive, so the aforementioned relative movement between the tool and the workpiece can be or is brought about by means of the electric motor in that the electric motor is supplied with the motor current, in particular during the current machining process. In some embodiments, the measured variable can comprise or be a deviation, in particular a control deviation, by at least two axes of the machine tool. One of the at least two axes can be a feed axis along which, for example, the workpiece and the tool are moved in a translatory manner relative to one another. A second of the at least two axes can be a spindle or spindle axis about which, for example, the tool and the workpiece are rotated relative to one another.

For example, measurement software is used, by means of which the measured variable is detected. In some embodiments, the measurement software is used to provide the above-mentioned measurement data, which characterize the detected measured variable. In some embodiments, in particular by way of the measurement software, the measurement data is available in real time or is made available or provided in real time.

For example, the measurement data or, for example, the measured variable and/or the measured value are stored in an electronic memory device, in particular the machine tool and preferably electronic computing device, and thus buffered. As a result, the measured value can, for example, be processed, in particular compared with the reference function, once the measured value has been determined or once the measured variable has been detected.

In some embodiments, at least one parameter which influences machining processes to be carried out by means of the machine tool is set, in other words changed or varied, as a function of the comparison, in particular during the machining process and/or by means of the electronic computing device. This parameter can thus be one of the aforementioned process parameters, wherein, by varying the parameter of the machining process, a respective machining process to be carried out by means of the machine tool can be varied or is varied for machining a respective workpiece.

For example, the process parameter, which is simply also referred to as a parameter, is automatically set, in particular by means of the electronic computing device, as a function of the comparison. In some embodiments, the parameter is set as a function of at least one input that is detected, in particular by means of the machine tool, and brought about by a person.

In some embodiments, in particular during the machining process, the determined measured value is compared with at least one second, preferably multi-dimensional, reference function, determined before the machining process on the basis of at least one second reference machining process carried out before the machining process by means of the machine tool and/or by means of the further machine tool and stored in the electronic memory device. The second reference function characterizes the second reference machining process carried out in order to machine at least one third workpiece of a third batch.

The preceding and following statements relating to the first reference machining process, the first reference function, the second workpiece and the second batch are also readily transferable to the second reference machining process, the second reference function, the third workpiece and the third batch, and vice versa. For example, the second reference machining process was or is carried out before or after the first reference machining process by means of the machine tool and/or by means of the further machine tool, wherein, in the second reference machining process or during the second reference machining process, the third workpiece was or is machined by means of the machine tool and/or by means of the further machine tool. In particular, the third workpiece was or is machined in the second reference machining process by means of the same tool by means of which the first workpiece is also or was also machined in the current machining process and/or the second workpiece is also or was also machined in the first reference machining process.

Furthermore, the preceding and following statements in relation to comparing the measured value with the first reference function can readily also be transferred to comparing the measured value with the second reference function, and vice versa. In some embodiments, the reference functions have the same dimensions and the same variables. As the respective name already expresses, the respective, e.g. multi-dimensional, reference function not only has one variable but a plurality of variables and thus a plurality of varying dimensions or a plurality of dimensions. The respective variables of the respective reference function are, for example, the process parameters or some of the process parameters. In particular, the respective reference function describes or defines a respective mutual dependence of the variables and thus of the process parameters.

By taking into account not only the first reference function but also the second reference function, a comprehensive, extensive reference base, also simply referred to as a base, is available with the aid of which any differences between the batches can be detected and compensated particularly early. In particular, by taking into account the reference base, it is possible to adapt the machine tool precisely to the first batch and thus to any differences between the first batch and the second batch and/or between the first batch and the third batch so the first batch or the workpieces of the first batch can be machined in a particularly process-reliable manner by means of the machine tool.

In some embodiments, the comparison of the measured value with the first reference function and/or with the second reference function, which takes place during the machining process and/or is carried out by means of the electronic computing device comprises that an especially mathematical combination, in particular a linear combination and in some cases a convex combination, is carried out, in other words is calculated, by means of the electronic computing device. In other words, for example, the first reference function is combined by means of the electronic computing device with the second reference function by way of a mathematical combination, in particular by a linear combination and preferably by a convex combination. By means of this combination, a multi-dimensional actual function, which comprises the measured value and characterizes the current machining process, is determined, in other words calculated or approximated.

The preceding and following statements in relation to the first reference function and/or second reference function can in this case also be readily transferred to the multi-dimensional actual function. This means that, for example, the actual function has the same dimension and the same variables as the respective reference function. The actual function is referred to as the actual function since it characterizes the current machining process and thus the machining of the first workpiece that is carried out or to be carried out by means of the machine tool. In particular, the actual function describes a mutual dependency or a mutual relationship of the process parameters during the execution of the current machining process, in other words in the case of the or a machining of the first batch or of the respective workpiece of the first batch.

In some embodiments, at least part of the multi-dimensional actual function is visualized by at least one function graph in that the function graph is displayed on an electronic display, in other words on an electronic screen, in particular of the machine tool. In some embodiments, at least one respective part of the respective reference function is also visualized by a respective reference function graph in that the respective reference function graph is displayed on the electronic display. The function graph and the reference function graph or the reference function graphs may be displayed on the electronic display at the same time.

As a result, for example, a person looking at the electronic display can visually perceive the function graph and the respective reference function graph, as a result of which the person can identify any differences between the batches quickly, simply and comprehensibly. In addition, the person can identify at least one dependency between the process parameters relating to the current machining process and thus the first batch on the basis of the function graph. In particular, the person can identify how any change in a first one of the process parameters can or would cause any change in a second one of the process parameters.

In some embodiments, at least one value of at least one first parameter or process parameter influencing machining processes to be carried out by means of the machine tool is calculated by means of the electronic computing device in such a way that at least one second value of at least one second parameter or process parameter, the dependence of which on the first parameter or process parameter is described by the actual function, meets at least one predefinable or predefined criterion. In other words, in this embodiment, an optimization process or an optimization function is carried out, in particular by means of the electronic computing device. Within the framework of the optimization function, the first value is determined in such a way that the second parameter assumes, for example, a desired parameter value in the form of the two values, or that the parameter value falls below or exceeds a predefined or predefinable limit. In this way, it is possible, for example, to operate the tool by setting the first value in such a way and, as a result, to machine the first batch by means of the machine tool in such a way that the respective workpiece of the first batch is machined by means of the machine tool as quickly as possible and/or as gently as possible for the machine tool and/or with the lowest possible occurring forces.

In some embodiments, the at least one first value of the at least one first parameter is automatically set by means of the electronic computing device. As a result, a particularly process-reliable and time- and cost-effective machining can be ensured.

In some embodiments, the at least one first value of the at least one first parameter is set as a function of at least one detected input brought about by a person. In such embodiments, for example, the person can be presented with a determined optimization potential in the form of the first value, it then being possible for the person to decide whether or not the first value is to be set.

In order to achieve particularly tailored machining, the at least one criterion may be set as a function of at least one detected input brought about by a person and is thereby predefined. This means that the person, who, for example, operates the machine tool, can set and thus specify the criterion, which is also referred to as an optimization criterion, so the at least one first parameter is optimized towards the optimization criterion predefined by the person.

In some embodiments, the method comprises the first reference machining process and/or the second reference machining process. The reference machining process, in other words the first and/or second reference machining process, is carried out before the current machining process, in which reference machining process, in particular if the reference machining process is the first reference machining process, the second workpiece is machined by means of the machine tool or by means of the further machine tool. During the reference machining process, the at least one measured variable is detected by means of the detection device of the machine tool, or of the further machine tool, with at least one reference measured value that characterizes the reference machining process being determined by means of the electronic computing device as a function of the measured variable detected during the reference machining process. In addition, the reference function is determined as a function of the reference measured value. In particular, the reference function is calculated. As a result, the machine tool can be set to any differences between the batches.

In some embodiments, the first reference function and/or the second reference function and/or the actual function and/or the measured value and/or the reference measured value and/or the at least one first value of the at least one first parameter is provided, in particular by the electronic computing device, and is loaded into a data cloud external in respect of the machine tool. From this data cloud, for example, a further machine tool external in respect of the machine tool can retrieve or download the respective reference function, the actual function, the measured value, the reference measured value and/or the first value. As a result, data determined by means of the machine tool can be used in or on the further machine tool in order to be able to machine, in particular cut, workpieces in a particularly process-reliable manner by means of the further machine tool. Not only can data be loaded into the data cloud (cloud), but data (reference functions) can also be loaded from the cloud and be applied or used for the current machining process.

In some embodiments, there is a machine tool for machining, in particular for mechanically machining workpieces, with the machine tool being designed to carry out a method as described herein. Advantages and advantageous embodiments of the methods are to be regarded as advantages and advantageous embodiments of the devices, and vice versa.

In some embodiments, the measured value is, for example, stored, in particular temporarily stored, and thus buffered. In particular, a plurality of measured variables is detected and/or a plurality of measured values of the measured variable is determined, so a plurality of measured values may be stored and thus buffered. Then, for example, the buffered measured values are analyzed on the basis of a model of the machining process, which is formed, for example, as a cutting process, with this model representing, in other words comprising, characteristic functions in the form of the reference functions for the material batches, in particular for the second batch and the third batch.

In some embodiments, the model represents the characteristic functions while taking into account the relevant process parameters such as tool wear, advance, cutting speed and cutting depth. This means that a first one of the process parameters can be a tool wear, in other words wear of the tool, a second of the process parameters can be an advance, a third of the process parameters can be a cut speed and a fourth of the process parameters can be a cutting depth. The preferably multi-dimensional actual function can also be a characteristic function or can be referred to as a characteristic function.

The respective characteristic function is designated, for example, by Fc. Furthermore, for example, the tool wear is designated by vb, the advance by f, the cutting speed by vc and the cutting depth by ap. Since the respective characteristic function Fc depends on f, vb, vc and ap, the characteristic function can also be described as:
Fc (f, ap, vc, vb).

In some embodiments, the model takes into account the tool and/or a machine-specific variance. The machine-specific variance should be taken to mean that the measured variable and thus the measured value are not only influenced by an interaction between the workpiece and the machine tool or the tool, but the measured variable and thus the measured value are also influenced by the machine tool itself, in other words influenced by machine-inherent factors such as, an internal friction of the machine tool. By taking into account the machine-specific variance, the respective machine-inherent factor can be subtracted, for example, from the measured variable or from the measured value, so the measured value and, for example, the actual function, characterizes the first workpiece and thus the first batch particularly precisely.

Since, for example, respective reference functions are obtained on the basis of a plurality of material batches, this plurality of reference functions forms a resulting function group which covers a defined working range of the process being focused on. This is conventionally given by the permitted cutting parameters of the tool. On the basis of the model, on the one hand optimized cutting parameters and their adaptation over time can be defined before the process on the basis of the cutting conditions which change as a result of the tool wear. On the other hand, by way of the buffered measured values it is already possible to estimate very early in the process and, for example, at the beginning of machining of a new workpiece, which material batch is present.

On this basis, the measurement data is, for example, analyzed by the formation of the convex combination, in particular for the interpolation of the characteristic function of a present material batch or of the first batch. The results, the expected forces in the course of continuous machining or cutting, and an estimation of the tool wear can be visualized for a person operating the machine tool, who is also referred to as an operator, in order, for example, to provide information about the material batch, in particular the material batch behavior thereof, and optionally to make adjustments for the process.

A support for this is provided by the optimization function, which determines a combination of the adaptable process parameters and thus, for example, minimizes the forces or keeps them particularly low during machining for optimally low tool wear. Thus, for example, the criterion can include the forces occurring during the respective machining process falling below a predefinable or predefined threshold and thus being, for example, as low as possible. In this case, for example, the optimized process parameters are accepted manually by the operator or automatically by a synchronization, in particular in a control program for operating, in particular for regulating or controlling, the machine tool. A selection of the variable or adaptable process parameters for the optimization can be configured and can thus be adapted to process specifications. In addition to the representation on the machine tool, a possibility of analysis across machines is provided, in particular by uploading or loading into the above-mentioned data cloud. Additional algorithms and an evaluation of suppliers according to machinability, in particular cutting machinability of the batches, are advantageously possible on this basis.

Compared to conventional methods, the methods herein make it possible, on the one hand, to increase the process reliability by adapting the process parameters to the present batch. On the other hand, the compensation leads to a lower outlay in the drawing-in of a new material batch and can save costs for the optimization of programs with regard to tool service life. The automatic adaptation of the process parameters also reduces the user interventions and thus saves the operator time.

The use of machine-internal signals, for example in the form of the measured variable, may be an advantageous aspect in order both to save costs for an additional sensor system and also to avoid restrictions on the machine tool by means of additional installations.

An algorithm is used for forming or determining or carrying out the combination, in particular the linear combination and preferably the convex combination, with the actual function and thus a machinability or a machining behavior of the first batch being approximated by the combination. The algorithm for determining the convex combination accesses this data, for example, and predicts the batch characteristics. In this case, the machine-specific reference behavior is represented by the statistical model or by the functional batch and thus by the respective function Fc. In addition, there may be continuity of the solution since the methods can act both on the machine tool itself and in the case of other, further machine tools, in particular via the data cloud. Global analyses are thus possible. An advantageous visualized production can also be represented by the visualization.

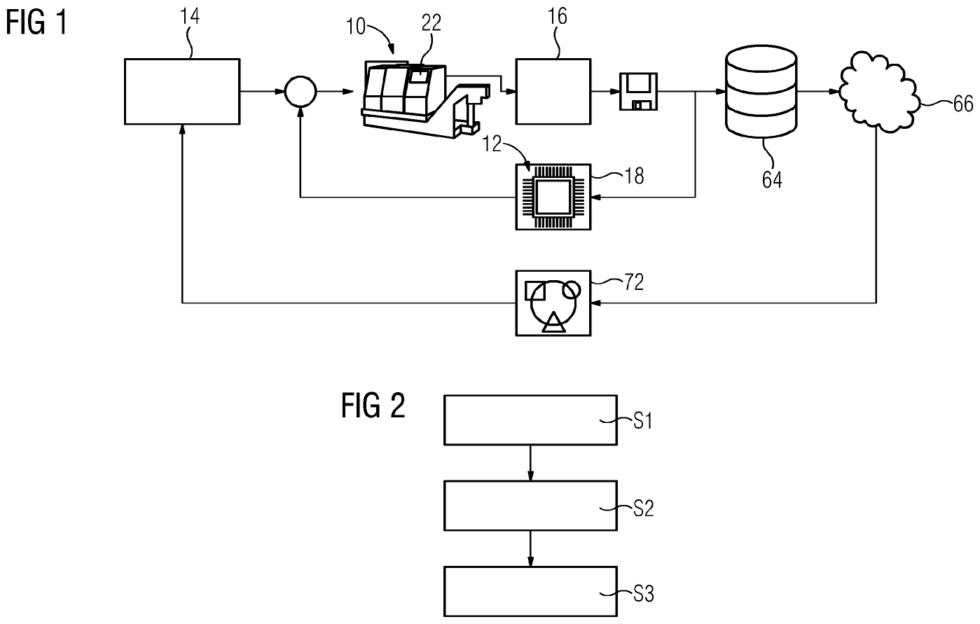

In the figures, identical or functionally identical elements are provided with the same reference characters. With reference to FIG. 1, a method for operating a machine tool 10, shown particularly schematically in FIG. 1, will be described below, with the machine tool 10 being designed to carry out the method. Workpieces can be machined, in particular mechanically cut, by the machine tool 10, so the machining process can be carried out in the form of cutting machining processes by means of the machine tool 10.

For this purpose, the machine tool 10 comprises a tool, which cannot be seen in the figures, and a drive, by means of which relative movements between the respective workpiece to be machined and the tool are brought about during the respective machining process, in particular while the tool at least temporarily touches the workpiece. As a result, the workpiece is machined by means of the tool and thus by means of the machine tool 10.

In the respective machining process, the machine tool 10 is operated, in particular controlled or regulated, for example by means of an electronic computing device, with the electronic computing device executing a program, in particular a numerical program, and in this case, for example, a regulating or control program. The electronic computing device can be a component of the machine tool 10, is shown schematically in FIG. 1 and is designated there by 12. The computing device 12 provides, for example, control signals, by means of which the drive is actuated and is thereby operated, in particular controlled or regulated.

In this case, for example, the machine tool 10 is supplied with design data 14 so the machine tool 10 is operated as a function of supplied construction data. On the basis of the construction data, which is derived or provided, for example by construction software, the respective workpiece is machined in order thereby to produce a component, described or defined, for example by the construction data, from the respective workpiece.

FIG. 2 shows a flowchart for further illustrating the example method. In the first step S1 of the method, during a machining process, in or during which at least one first workpiece of a first batch, which is also referred to as the first material batch, is machined by means of the machine tool 10, at least one measured variable is detected by means of an internal detection device of the machine tool 10.

This internal detection device of the machine tool 10 is illustrated schematically in FIG. 1 and is designated there by 16. The measured variable is, for example, an electric current, also referred to as motor current, which flows through the drive or with which the drive is supplied, in order thereby to move the workpiece and the tool relative to one another. In some embodiments, the measured variable can comprise an electrical voltage which is applied to the drive or with which the drive is supplied in order thereby to move the tool and the workpiece relative to one another by means of the drive.

In order to measure the motor current or the voltage, the measuring device 16 comprises, for example, a current meter, for example the detection device 16, which is also referred to as a measuring device, comprises measuring software which is executed by the electronic computing device 12 and detects the measured variable and/or, as a function of the measured variable in a second step S2 of the method, calculates at least one measured value characterizing the machining process, as a function of the BG detected during the machining process. In other words, in the second step S2, it is provided that, in particular by means of the electronic computing device 12, said measured value is determined, in particular calculated, as a function of the detected measured variable. The measured value is characterized, for example, by data, which is also referred to as machine data or measurement data. The machine data is fed to the electronic computing device 12, for example, so the electronic computing device 12 can operate the machine tool 10 as a function of the machine data.

In a third step S3 of the method, the determined measured value is compared with at least one multi-dimensional reference function stored in an electronic memory device 18, in particular the electronic computing device 12, with, for example, the measured value being compared with the reference function by means of the electronic computing device 12. The reference function is or was determined on the basis of at least one reference machining process carried out by means of the machine tool 10 before the machining process, with the reference function characterizing the reference machining process carried out in order to machine at least one second workpiece of a second batch.

In other words, within the scope of the reference machining process, a second workpiece of a second batch is or was machined by means of the machine tool 10, in particular mechanically machined or machined by cutting, wherein the multi-dimensional reference function characterizes the reference machining process. In particular, the reference function defines or describes a mutual dependence of process parameters, also referred to simply as parameters, on the basis of which the machine tool 10 was operated, in particular controlled or regulated, in particular by the electronic control device 12, during the reference machining process in order to machine the second workpiece of the second batch during the reference machining process.

In some embodiments, at least one second reference machining process was or is carried out before the machining process, with the second reference machining process being carried out before or after the first reference machining process. A second multi-dimensional reference function, which characterizes the second reference machining process, is or was determined on the basis of the second reference machining process. In the second reference machining process, at least one third workpiece of a third batch is or was machined by means of the machine tool 10.

In some embodiments, the second reference function describes a mutual dependence of the process parameters on the basis of which the machine tool 10 was or is operated, in particular controlled or regulated, in particular by means of the electronic computing device 12, during the second reference machining process. The multi-dimensional reference functions have the same dimension and the same variables or process parameters, in particular with regard to their type, so the process parameters, whose mutual dependence is described by the first reference function, are the same process parameters as the process parameters, whose dependence is described by the second reference function, but the process parameters whose mutual dependence is described by the first reference function, differ, for example with regard to their respective values, from the process parameters whose dependence is described by the second reference function.

In this case, for example, the measured value is also compared with the second reference function by means of the electronic computing device 12. In some embodiments, the comparison comprises the fact that a convex combination of the multi-dimensional reference functions is carried out by means of the electronic computing device, as a result of which a multi-dimensional actual function comprising the measured value and characterizing the machining process is determined. The reference function and the actual function have the same variables or process parameters and the same dimension. The process parameters can be, for example, wear of the tool, an advance by a cutting speed and/or a cutting depth.

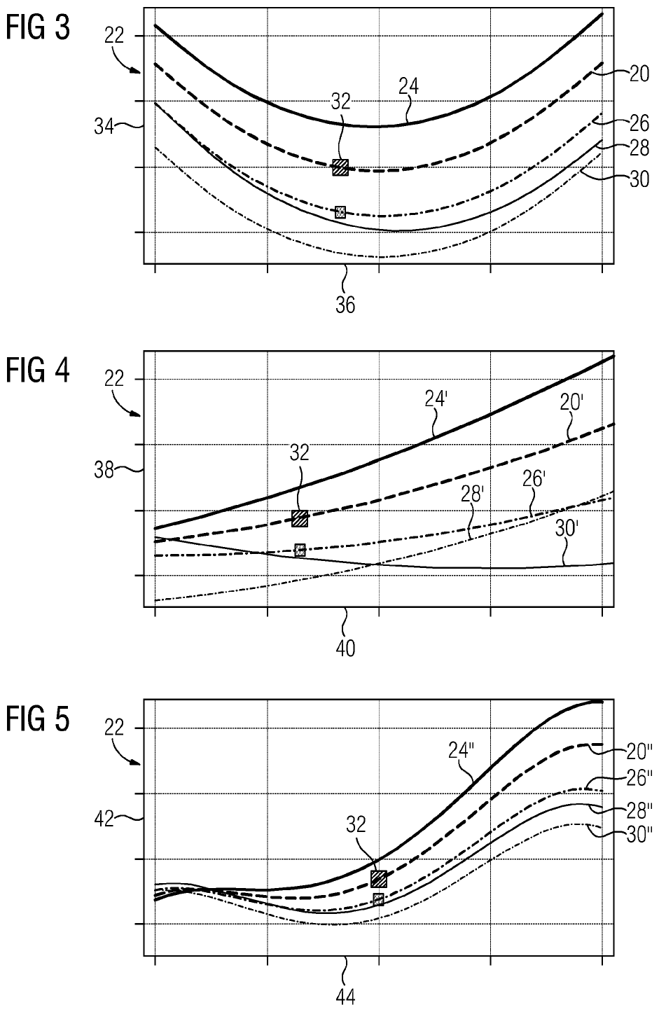

It can be seen from FIG. 3 to 5 that, for example, at least a first part of the multi-dimensional actual function is visualized by a first function graph 20 in that the function graph 20 is displayed on an electronic display 22, in particular of the machine tool 10, and this is also referred to as an electronic screen. In addition, at least respective parts of the first and second reference functions and a third and fourth reference function are visualized by respective function graphs 24, 26, 28 and 30 in that the function graphs 24, 26, 28 and 30 are displayed on the display 22. The function graphs 20, 24, 26, 28 and 30 are simultaneously displayed on the display 22. In addition, the above-mentioned measured value can be seen in FIG. 3 and is designated there by 32. In particular, the measured value 32 can be a measurement point. It can be seen particularly well from FIG. 3 that the actual function is a convex combination of the reference function and was or is approximated by this convex combination.

FIG. 4 illustrates that, alternatively or in addition, the actual function and the reference functions can be visualized by the respective function graph 20′, 24′, 26′, 28′ and 30′ being displayed simultaneously on the display 22 at least on respective parts of the actual function and the reference functions. This can also be seen from FIG. 5, which illustrates that, alternatively or in addition, further function graphs 24″, 26″, 28″ and 30″ can be displayed simultaneously on the display 22, which graphs show at least respective parts of the actual function and the reference function.

For example, FIG. 3 illustrates a mutual dependence of a first one of the process parameters and a second one of the process parameters, the first process parameter being designated by 34 and plotted on the ordinate, the second process parameter being designated by 36 and plotted on the abscissa. The first process parameter is, for example, the motor current and the second process parameters is, for example, the cutting speed.

By contrast, FIG. 4 illustrates a mutual dependence of a third one of the process parameters and a fourth one of the process parameters, wherein the third process parameter is designated by 38 and the fourth process parameter is designated by 40. The third process parameter is plotted on the ordinate, for example, and is the motor current, with the fourth process parameter being, for example, the advance.

In addition, FIG. 5 illustrates a mutual dependence of a fifth one of the process parameters and a sixth one of the process parameters, the fifth process parameter being designated by 42 and the sixth process parameter being designated by 44. The fifth process parameter is, for example, the motor current, while the sixth process parameter is, for example, the tool wear. For example, by varying one of the process parameters, in particular by varying a value of one of the process parameters, at least one other of the process parameters, in particular a value of one other of the process parameters, is influenced, for example, since the process parameters are mutually dependent. This mutual dependence of the process parameters is described by the actual function or by the respective reference function.

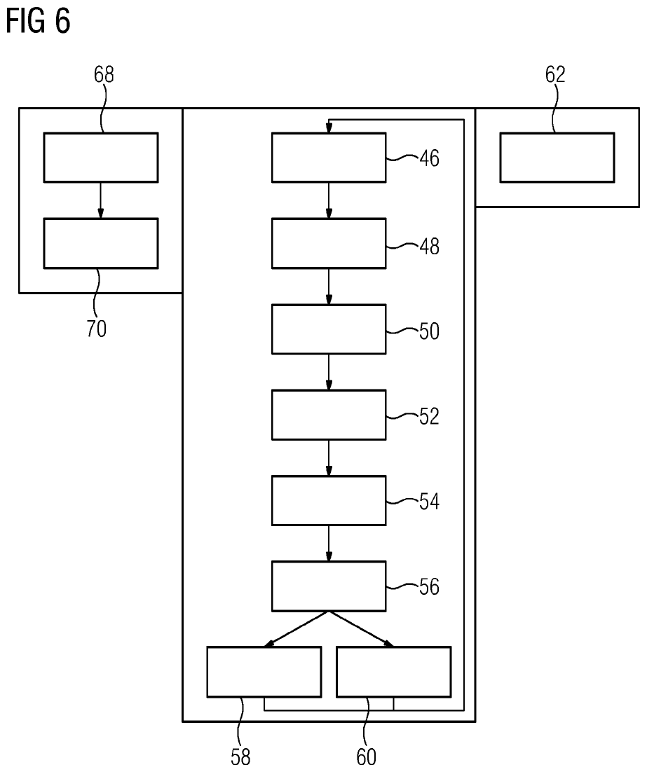

Finally, FIG. 6 shows block diagrams for further illustrating the example methods. In a block 46, for example the buffered measured values or machine data, also referred to as axis values, are read out. In a block 48, for example, the tool wear is calculated on the basis of the read-out axis values and on the basis of an intervention history. In a block 50, for example the measured values are filtered. In a block 52, the convex combination is formed in order to approximate the actual function and thus the current first batch, in particular the cutting behavior thereof.

In a block 54, a visualization takes place, in the framework of which, for example, said function graphs are displayed on the display line 22. In a block 56, for example, an optimization of the variables and thus adjustable process parameters takes place, in particular in such a way that, for example, at least one first value of at least one first one of the process parameters influencing the machining processes to be carried out by means of the machine tool 10 is calculated by means of the electronic computing device 12, in such a way that at least one second value of a second one of the process parameters fulfills a predefinable or predefined criterion and, for example, corresponds to a desired value and/or exceeds a threshold value and/or falls below a limit value.

In a block 58, the process parameters are automatically adapted so, for example, the calculated first value is automatically set by means of the electronic computing device 12. In some embodiments, a manual adaptation of the process parameters takes place in a block 60 in that, for example, the calculated first value or a further value of the first process para which is different therefrom is set by a person operating the machine tool.

The blocks 46, 48, 50, 52, 54, 56, 58 and 60 thus illustrate a sequence on the machine tool 10. A block 62 illustrates downstream processing of the data determined or calculated within the scope of the method, which data is also referred to as process data. This process data is shown schematically in FIG. 1 and designated by 64. For example, the process data 64 is transferred into a data cloud 66, which is also referred to as a cloud external in respect of the machine tool 10.

In particular, the process data comprises at least one of the reference functions and/or the actual function, so, for example, the process data 64 characterizes the first batch and/or the second batch and/or the third batch. Blocks 68 and 70 illustrate a configuration. In the block 68, a statistical model is adapted to the machine tool 10. The statistical model uses the reference functions and thus the function group formed by the reference functions. In a block 70, the statistical model is adapted to the tool. The statistical model therefore takes into account, for example, the tool and the machine tool 10, in particular machine-specific variances.

Finally, it can be seen from FIG. 1 that the process data 64 can be retrieved from the data cloud 66 and can be used, for example, for a process optimization 72, wherein findings obtained from the process optimization 72 can flow into the design data 14 or into further design data.

What is claimed is:

1. A method for operating a machine tool, the method comprising:
during a machining process in which a first workpiece of a first batch is machined using the machine tool, detecting a measured variable using a detection device of the machine tool;
determining a measured value characterizing the machining process as a function of the measured variable using an electronic computing device; and
comparing the determined measured value with a reference function determined before the machining process using a reference machining process carried out before the machining process using the machine tool and/or by a further machine tool and stored in an electronic memory device, the reference function characterizing the reference machining process to machine a second workpiece of a second batch.

2. The method as claimed in claim 1, further comprising setting a parameter influencing machining processes to be carried out by the machine tool as a function of the comparison.

3. The method as claimed in claim 1, further comprising comparing the determined measured value with a second reference function determined before the machining process on the basis of a second reference machining process carried out by the machine tool and/or by a further machine tool before the machining process and stored in the electronic memory device, wherein the second reference function characterizes the second reference machining process carried out to machine a third workpiece of a third batch.

4. The method as claimed in claim 3, wherein the comparison comprises combining the reference functions using the electronic computing device and determining an actual function comprising the measured value and characterizing the machining process.

5. The method as claimed in claim 4, wherein at least part of the actual function is visualized by a function graph displayed on an electronic display.

6. The method as claimed in claim 4, further comprising calculating a first value of a first parameter influencing machining processes to be carried out by the machine tool using the electronic computing device so a second value of a second parameter fulfils a predefined criterion;
wherein the second parameter depends on the first parameter as described by the actual function.

7. The method as claimed in claim 6, further comprising automatically setting the first value of the first parameter using the electronic computing device.

8. The method as claimed in claim 6, further comprising setting the first value of the first parameter a function of a detected input brought about by a person.

9. The method as claimed in claim 6, further comprising setting the criterion a function of a detected input brought about by a person.

10. The method as claimed in claim 1, further comprising, before the machining process, carrying out the reference machining process,
wherein the second workpiece is machined by the machine tool;
detecting, during the reference machining process, the measured variable using the detection device of the machine tool;
determining a reference measured value characterizing the reference machining process using the electronic computing device as a function of the measured variable detected during the reference machining process; and
determining the reference function as a function of the reference measured value.

11. The method as claimed in claim 1, wherein the reference function and/or the actual function and/or the measured value and/or the reference measured value and/or the first value of the first parameter is provided and loaded into a data cloud external to the machine tool.

12. A machine tool for machining workpieces, the machine tool comprising:
a tool bit;
a machine for articulating the tool bit; and
a controller programmed to:
during a machining process in which a first workpiece of a first batch is machined using the machine tool, detect a measured variable using a detection device of the machine tool;
determine a measured value characterizing the machining process as a function of the measured variable using an electronic computing device; and
compare the determined measured value with a reference function determined before the machining process using a reference machining process carried out before the machining process using the machine tool and/or by a further machine tool and stored in an electronic memory device, the reference function characterizing the reference machining process to machine a second workpiece of a second batch.
